(19) United States
(12) Patent Application Publication
(10) Pub. No.: US 2026/0121922 A1
(43) Pub. Date: Apr. 30, 2026

(54) SYSTEM AND METHOD FOR ENHANCING NETWORK EXPERIENCE

(71) Applicant: Network Innovations, LLC, Chicago, IL (US)

(72) Inventors: Fleming Shi, Scotts Valley, CA (US); Thomas Gamet, Orlando, FL (US)

(21) Appl. No.: 19/369,148

(22) Filed: Oct. 24, 2025

Related U.S. Application Data
(60) Provisional application No. 63/712,008, filed on Oct. 25, 2024.

(51) Int. Cl. H04L 41/0816; G06F 40/205; H04L 43/0823; H04L 43/0852; H04L 43/0876

(52) U.S. Cl. CPC H04L 41/0816; G06F 40/205; H04L 43/0823; H04L 43/0852; H04L 43/0876

(57) ABSTRACT

The present disclosure provides a system for optimizing network performance based on correlated multi-source experiential feedback. The system includes a data pipeline comprising a telemetry ingestion module configured to collect structured system data and a natural language parser configured to extract sentiment-weighted indicators from unstructured user feedback data. An analytical artificial intelligence (AI) module identifies patterns and anomalies in the data. A correlation AI engine generates time-aligned embeddings and computes relationships between network events and user dissatisfaction. A generative AI module produces system modification recommendations based on correlation engine outputs. An action operator automatically deploys configuration changes to infrastructure nodes, monitors outcomes, and triggers rollback operations in response to performance regressions, without human intervention.

### CROSS-REFERENCE TO RELATED APPLICATIONS

This application claims priority to U.S. Application No. 63/712,008, titled “SYSTEM AND METHOD FOR ENHANCING NETWORK EXPERIENCE THROUGH CONVERGED ANALYTICS AND GENERATIVE AI MODELS UTILIZING REAL-TIME DATA INPUTS”, filed Oct. 25, 2024, which is hereby incorporated by reference in its entirety.

### BACKGROUND

Networking has become an integral part of modern life, connecting various devices and systems across diverse environments. From large-scale data centers to home networks and mobile devices, the interconnectedness of our digital infrastructure supports a wide range of applications that impact daily activities, including work, social interactions, online commerce, financial transactions, and entertainment.

As networks have grown in complexity and importance, the measurement and analysis of network performance have traditionally been the domain of network administrators. However, the correlation between network metrics and broader user experience has often been challenging to establish. This disconnect can lead to situations where technical indicators may not fully capture the actual impact on end-users.

The proliferation of Internet of Things (IoT) devices has further expanded the scope and scale of networked systems, introducing additional layers of complexity to performance monitoring and optimization. These devices generate vast amounts of data, which can be valuable for understanding network behavior but also present challenges in terms of data processing and interpretation.

Existing approaches to network performance assessment often focus on isolated technical parameters without fully considering the holistic user experience. This limited perspective can result in missed opportunities for improvement and may not adequately address the diverse needs of different user groups across various applications and services.

Furthermore, the dynamic nature of modern network usage patterns, influenced by factors such as time of day, geographical location, and specific application requirements, adds to the complexity of maintaining consistent performance and user satisfaction. Traditional static analysis methods may struggle to capture these nuanced variations effectively.

Improvements are needed.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The present disclosure relates to network performance optimization systems, and more particularly to a system and method for enhancing network experience using converged analytics and generative artificial (AI) models utilizing real-time data inputs.

According to an aspect of the present disclosure, a system for optimizing network performance based on correlated multi-source experiential feedback is provided. The system includes a data pipeline comprising a telemetry ingestion module configured to collect structured system data including timestamped network performance metrics from network devices, and a natural language parser configured to extract sentiment-weighted indicators from unstructured user feedback data obtained from support cases or surveys. The system also includes an analytical AI module comprising at least one predictive model or classification algorithm configured to identify patterns and anomalies in the structured system data and the unstructured user feedback data. Additionally, the system includes a correlation AI engine configured to generate time-aligned embeddings of the structured system data and sentiment-weighted experiential data and to compute relationships between network events and user dissatisfaction using time-series correlation and multi-dimensional vector analysis. The system further includes a generative AI module configured to produce system modification recommendations in response to output signals from the correlation AI engine. Lastly, the system includes an action operator comprising a network orchestration interface configured to automatically deploy configuration changes to infrastructure nodes, monitor outcomes of the changes, and trigger rollback operations in response to performance regressions, all without human intervention.

According to other aspects of the present disclosure, the system may include one or more of the following features. The network performance metrics may include at least one of bandwidth usage, error rates, or latency. The unstructured user feedback data may comprise audio data. The at least one predictive model or classification algorithm may identify patterns in network performance and correlate the patterns with user experience metrics. The correlation AI engine may use time-series analysis to map network events to corresponding user feedback. The correlation AI engine may be configured to handle multi-dimensional correlations factoring in variables including geography, time of day, and device type. The action operator may be configured to implement changes through automated tasks based on user consent and may include monitoring capabilities and rollback features.

According to another aspect of the present disclosure, a method for enhancing network experience is provided. The method includes collecting structured system data and unstructured experiential data to generate collected data, processing the collected data through a data pipeline to generate processed data, analyzing the processed data using an analytical AI module, identifying relationships between network performance and user experience using a correlation AI engine based on outputs from the data pipeline and the analytical AI module, generating recommendations using a generative AI module based on inputs from the correlation AI engine, and implementing changes based on the generated recommendations using an action operator.

According to other aspects of the present disclosure, the method may include one or more of the following features. The structured system data may comprise network performance metrics including bandwidth usage, error rates, and latency. The unstructured experiential data may comprise user feedback from support cases and surveys. The analyzing the processed data using the analytical AI module may comprise utilizing predictive models and classification algorithms to identify patterns in network performance and correlate them with user experience metrics. The identifying relationships between the network performance and the user experience may further comprise using time-series analysis to map network events to corresponding user feedback. The identifying relationships between the network performance and the user experience may further comprise handling multi-dimensional correlations factoring in variables including geography, time of day, and device type. The implementing changes may comprise executing automated tasks based on user consent and may include monitoring the implemented changes and providing rollback features.

According to another aspect of the present disclosure, a non-transitory computer-readable medium storing instructions that, when executed by a processor, cause the processor to perform operations for enhancing network experience is provided. The operations include collecting structured system data and unstructured experiential data to generate collected data, processing the collected data to generated processed data, analyzing the processed data to generate analyzed data, identifying relationships between network performance and user experience based on the analyzed data, generating recommendations based on the identified relationships, and implementing changes based on the generated recommendations.

According to other aspects of the present disclosure, the non-transitory computer-readable medium may include one or more of the following features. The structured system data may comprise network performance metrics including bandwidth usage, error rates, and latency. The unstructured experiential data may comprise user feedback from support cases and surveys. The analyzing the processed data may comprise utilizing predictive models and classification algorithms to identify patterns in network performance and correlate them with user experience metrics. The identifying relationships between the network performance and the user experience may further comprise using time-series analysis to map network events to corresponding user feedback. The identifying relationships between the network performance and the user experience may further comprise handling multi-dimensional correlations factoring in variables including geography, time of day, and device type.

These and other features and advantages are described in greater detail below.

### BRIEF DESCRIPTION OF THE DRAWINGS

The accompanying drawings, which are incorporated in and constitute a part of this specification, show embodiments and together with the description, serve to explain the principles of the methods and systems: Some features are shown by way of example, and not by limitation, in the accompanying drawings. In the drawings, like numerals reference similar elements.

FIG. 1 illustrates a block diagram of a system for processing and analyzing data using artificial intelligence according to the present disclosure.

FIG. 2 illustrates a block diagram of a data formatter according to the present disclosure.

FIG. 3 illustrates a block diagram of a correlation AI engine, according to the present disclosure.

FIG. 4 illustrates parallel timelines showing the relationship between network telemetry and user complaints according to the present disclosure.

FIG. 5 illustrates a system diagram of a network experience enhancement system according to the present disclosure.

FIG. 6 illustrates a flowchart of a method for processing and analyzing data according to the present disclosure.

The accompanying drawings show examples of the disclosure. It is to be understood that the examples shown in the drawings and/or discussed herein are non-exclusive and that there are other examples of how the disclosure may be practiced.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to systems and methods for enhancing network experience through the use of converged analytics and generative artificial intelligence (AI) models. This approach combines advanced data analysis techniques with AI-driven insights to improve network performance and user satisfaction.

The system may collect and process both structured data from network devices and unstructured data from user feedback. The structured data may include network performance metrics, while the unstructured data may comprise user comments, complaints, or survey responses.

The system may utilize various AI components to analyze the collected data. An analytical AI module may identify patterns and anomalies in network performance and user experience. A correlation engine may establish relationships between network events and user satisfaction levels. A generative AI module may produce recommendations for system modifications based on these analyses.

The system may include an action component capable of automatically implementing recommended changes to network infrastructure. This component may monitor the outcomes of these changes and revert modifications if necessary.

By integrating these various elements, the system may provide a comprehensive approach to network optimization. The system may continuously adapt to changing conditions and user needs, potentially leading to improved network performance and enhanced user experience.

In modern society, networking plays a crucial role in various aspects of daily life. From large-scale hyperscalers to office environments, homes, and mobile devices, interconnected systems have become ubiquitous. The proliferation of Internet of Things (IoT) devices across different settings further emphasizes the pervasive nature of networked technology.

Applications that rely on these networks have a significant impact on numerous activities, including work-related tasks, social interactions, online commerce, financial transactions, and entertainment. However, the true user experience of these networked applications often remains obscured, as existing systems may not always provide a comprehensive picture of performance and user satisfaction.

While network administrators have traditionally measured network performance, there has been a challenge in correlating these metrics with broader improvements in user experience. This disconnect between network performance data and actual user satisfaction presents an opportunity for more sophisticated analysis and optimization techniques.

The complexity of modern networks, combined with the diverse range of applications and user expectations, creates a need for more advanced methods of evaluating and enhancing network performance. By developing systems that can effectively correlate network metrics with user experience data, it may be possible to gain deeper insights into how network performance impacts overall user satisfaction across various domains and use cases.

The present disclosure proposes a novel approach that integrates advanced analytics artificial intelligence (AI) models with sophisticated generative AI systems. This integration may leverage extensive datasets derived from user experiences to establish a comprehensive and detailed regressive experience profile.

The system may dynamically adjust based on multiple factors. These factors may include application usage metrics, temporal variables, geographical data, and customer satisfaction indices. The combination of data analytics AI and generative AI may enable operation at an unprecedented level of sophistication.

The convergence of these AI technologies may leverage their combined intelligence to enhance and optimize user experience. By utilizing both analytical and generative capabilities, the system may provide more comprehensive insights and actionable recommendations.

The analytics AI models may process and analyze large volumes of structured and unstructured data related to network performance and user feedback. These models may identify patterns, anomalies, and correlations within the data.

The generative AI systems may use the outputs from the analytics models to create tailored recommendations, reports, or even automated responses. These generative systems may produce human-readable summaries of complex data analyses or generate specific action plans to address identified issues.

The synergy between the analytics and generative AI components may allow for a more nuanced understanding of user experiences. This approach may enable the system to not only identify problems but also propose and implement solutions in a more efficient and effective manner.

By continuously processing new data and refining its models, the system may adapt to changing network conditions and evolving user needs. This dynamic approach may lead to ongoing improvements in network performance and user satisfaction over time.

The system may include a generative AI module. The generative AI module may be implemented as a Large Language Model (LLM). The LLM may be a recently trained model with capabilities for processing and generating natural language text.

The generative AI module may have various functionalities related to natural language processing and generation. The module may be capable of summarizing text inputs. This summarization capability may allow the system to condense large amounts of information into more concise and digestible formats.

Additionally, the generative AI module may possess analytical capabilities. The module may be able to examine and interpret textual data, potentially extracting key insights or identifying important patterns within the text.

The generative AI module may also have the ability to produce written content in natural languages. This writing capability may enable the module to generate human-readable outputs based on its analysis and processing of input data.

The generative AI module may produce system modification recommendations. These recommendations may be generated in response to output signals received from other components of the system, such as a correlation AI engine. The module may utilize its natural language generation capabilities to formulate these recommendations in a clear and understandable manner.

The combination of summarization, analysis, and writing capabilities within the generative AI module may allow for versatile processing and output of information within the system. This functionality may contribute to the overall goal of enhancing network experience through advanced AI-driven analysis and recommendations.

The system may include an experiential data collector configured to process unstructured user feedback data. The experiential data collector may collect user feedback from various sources, such as support cases or surveys. This feedback may comprise textual data, audio recordings, or other forms of unstructured information.

The experiential data collector may incorporate a natural language parser. The natural language parser may be configured to extract sentiment-weighted indicators from the unstructured user feedback data. These sentiment-weighted indicators may provide insights into user satisfaction levels and specific areas of concern.

The experiential data collector may process audio data as part of the unstructured user feedback. The system may employ speech-to-text conversion techniques to transform audio feedback into textual data for further analysis.

The experiential data collector may include data processing modules designed to convert unstructured feedback into structured formats suitable for analysis. These modules may transform the unstructured data into vectorized representations. This vectorization process may enable more efficient computational analysis and comparison of user feedback.

Additionally, the experiential data collector may generate inverted indexes based on the processed feedback data. These inverted indexes may facilitate rapid searching and retrieval of relevant information from the collected user feedback.

The combination of vectorized data and inverted indexes may enable a technique known as Retrieval Augmented Generation (RAG). This approach may allow the system to efficiently access and utilize relevant user feedback when generating responses or recommendations.

By processing and structuring user feedback in this manner, the experiential data collector may provide valuable inputs for other components of the system. The collected and processed experiential data may contribute to a more comprehensive understanding of user experiences and network performance issues.

The system may include a system data collector configured to ingest structured data from various network devices. The system data collector may be implemented as part of a data pipeline that processes both structured and unstructured data inputs.

The system data collector may interface with network devices such as gateways, routers, and controllers to gather structured performance data. This structured data may include various network performance metrics that are typically captured and managed by these devices.

The system data collector may incorporate a telemetry ingestion module. This module may be designed to collect structured system data from the network devices. The collected data may include timestamped network performance metrics, allowing for temporal analysis of network behavior.

The network performance metrics gathered by the system data collector may encompass various aspects of network operation. These metrics may include bandwidth usage data, providing insights into network capacity utilization. The collected data may also include error rates, which can indicate potential issues or inefficiencies in network communication.

Additionally, the system data collector may gather latency information as part of its network performance metrics. Latency data may provide valuable information about the responsiveness and speed of network connections.

By collecting these structured data points, the system data collector may enable comprehensive analysis of network performance. The collected data may serve as input for various analytical processes within the system.

The structured data collected by the system data collector may be used as features for contextual generative AI processes. This integration of structured network data with AI systems may allow for more nuanced and context-aware analysis and recommendations.

The system data collector may work in conjunction with other components of the data pipeline, such as modules designed to process unstructured data. This combination of structured and unstructured data processing capabilities may contribute to a more holistic approach to network analysis and optimization.

The system may include an analytical AI module configured to process and analyze data inputs. The analytical AI module may be designed to handle both structured and unstructured data types.

The analytical AI module may incorporate various artificial intelligence and machine learning models. These models may include generative AI systems as well as traditional machine learning algorithms. The combination of different model types may allow for a hybrid approach to data analysis.

The analytical AI module may utilize predictive models. These predictive models may be trained to identify patterns within network performance data. The models may analyze historical network metrics to detect recurring trends or anomalies.

The analytical AI module may also employ classification algorithms. These algorithms may be used to categorize different types of network events or user feedback. By classifying data points, the module may enable more targeted analysis and response strategies.

The analytical AI module may be capable of correlating patterns in network performance with user experience metrics. This correlation may involve mapping specific network events or conditions to corresponding user feedback or satisfaction indicators.

The analytical AI module may process structured system data, which may include quantitative network performance metrics. Simultaneously, the module may analyze unstructured user feedback data, which may comprise qualitative information about user experiences.

By combining the analysis of both structured and unstructured data, the analytical AI module may provide a more comprehensive understanding of network performance and its impact on user satisfaction. This integrated approach may allow for the identification of subtle relationships between technical metrics and user-reported experiences.

The analytical AI module may be designed to identify anomalies in both the structured system data and the unstructured user feedback data. These anomalies may represent unusual network behavior or unexpected patterns in user responses that warrant further investigation.

The hybrid approach employed by the analytical AI module, utilizing various AI and machine learning models, may enable flexible and adaptive analysis. This approach may allow the module to handle diverse data types and adapt to changing network conditions and user expectations over time.

The system may include a correlation AI engine designed to establish connections between network performance data and user experience information. The correlation AI engine may employ time-series analysis techniques to map specific network events to corresponding user feedback.

The correlation AI engine may generate time-aligned embeddings of structured system data and sentiment-weighted experiential data. This alignment process may enable more accurate comparisons between network performance metrics and user satisfaction indicators over time.

The correlation AI engine may be configured to handle multi-dimensional correlations. These correlations may factor in various variables, including geographical location, time of day, and device type. By considering multiple dimensions, the engine may provide a more nuanced understanding of the relationships between network events and user experiences.

The correlation AI engine may compute relationships between network events and user dissatisfaction using time-series correlation methods. Additionally, the engine may employ multi-dimensional vector analysis techniques to further refine these computations.

The correlation AI engine may utilize advanced techniques such as Chain of Thought reasoning to adjust time-series analysis based on user experience data. This approach may allow for more sophisticated interpretations of the relationships between network performance and user feedback.

The multi-dimensional correlation capabilities of the engine may enable a more comprehensive analysis of network performance impacts. By considering factors such as geography, time of day, and device type, the engine may identify patterns or issues that might not be apparent through simpler analysis methods.

The system may include a recommendation AI engine configured to provide recommendations across multiple domains. The recommendation AI engine may generate recommendations related to network configuration, application adjustments, and user-side tips.

The recommendation AI engine may utilize generative AI capabilities to produce recommendations. The generative AI component may create initial drafts of recommendations. These drafts may be generated in formats that are easily shareable with relevant stakeholders.

The recommendation AI engine may be designed to predict potential actions before issues occur. By analyzing patterns in network performance and user feedback, the engine may anticipate potential problems and suggest preemptive measures.

The recommendation AI engine may incorporate user engagement data into its analysis. The engine may consider changes in user behavior or responses to previous recommendations when formulating new suggestions.

The recommendation AI engine may also utilize survey data as part of its recommendation process. Feedback collected through user surveys may inform the engine's understanding of user preferences and satisfaction levels, potentially influencing the nature of its recommendations.

The recommendation AI engine may produce recommendations in multiple formats to facilitate easy sharing and comprehension. These formats may include textual summaries, visual representations, or structured action plans.

The recommendation AI engine may continuously refine its recommendation strategies based on the effectiveness of previous suggestions. By monitoring the outcomes of implemented recommendations, the engine may adapt its approach to better address recurring issues or emerging challenges in network performance and user experience.

The system may include an action operator configured to translate recommendations into executable tasks. The action operator may interact with both system components and users to implement changes based on generated recommendations.

The action operator may incorporate a network orchestration interface. This interface may enable the action operator to automatically deploy configuration changes to infrastructure nodes within the network. By interfacing directly with network components, the action operator may implement modifications without requiring manual intervention.

The action operator may utilize application programming interfaces (APIs) for system interactions. These APIs may allow the action operator to communicate with various network devices and management systems, facilitating the execution of configuration changes and other tasks.

The action operator may also employ natural language processing (NLP) based human interfaces to interact with users. These interfaces may enable more intuitive communication between the system and human operators, potentially improving the clarity and effectiveness of user interactions.

The action operator may be designed to implement changes through automated tasks. These automated tasks may be executed based on user consent, allowing for a balance between automation and human oversight. The consent-based approach may provide users with control over significant system modifications while still leveraging the efficiency of automated processes.

The action operator may include monitoring capabilities to track the outcomes of implemented changes. This monitoring may allow the system to assess the effectiveness of modifications and detect any unintended consequences or performance issues resulting from the changes.

In addition to monitoring, the action operator may incorporate rollback features. These features may enable the system to revert changes in response to detected performance regressions or other issues. The ability to automatically roll back modifications may help maintain system stability and prevent prolonged negative impacts from unsuccessful changes.

The action operator may be capable of triggering rollback operations without human intervention. This automated rollback capability may allow for rapid response to performance issues, potentially minimizing downtime or service degradation.

The combination of automated deployment, monitoring, and rollback features may enable the action operator to manage network changes more efficiently. By automating these processes while still allowing for user oversight, the system may balance the benefits of automation with the option for human control in some network management tasks.

The system may collect data from multiple sources to enable comprehensive analysis of network performance and user experience. The system may gather both structured data from network devices and unstructured data from user feedback.

The structured data collection process may involve obtaining telemetry information from network infrastructure components. This structured system data may include quantitative metrics related to network performance. The system may collect timestamped network performance metrics, allowing for temporal analysis of network behavior.

Concurrently, the system may collect unstructured experiential data from various sources. This unstructured data may comprise user feedback obtained through support cases or surveys. The unstructured data may include textual comments, audio recordings, or other forms of qualitative feedback from users.

The system may process the collected data through a data pipeline to prepare it for further analysis. The data pipeline may include specialized modules for handling different data types.

For structured data processing, the system may employ data cleaning and normalization techniques. These processes may ensure consistency in the format and scale of the collected network performance metrics. The system may aggregate or summarize the structured data to facilitate efficient analysis.

The processing of unstructured data may involve natural language processing techniques. The system may extract sentiment-weighted indicators from the unstructured user feedback. This extraction process may involve analyzing the text or audio content to determine user satisfaction levels and identify specific areas of concern.

The data pipeline may convert unstructured feedback into structured formats suitable for computational analysis. This conversion process may include vectorization of textual data or the creation of numerical representations of user sentiment.

The data pipeline may also generate searchable indexes based on the processed feedback data. These indexes may enable rapid retrieval of relevant information from the collected user feedback during subsequent analysis stages.

By processing both structured and unstructured data through the data pipeline, the system may create a unified dataset that combines quantitative network performance metrics with qualitative user experience information. This integrated approach may enable more comprehensive analysis of the relationships between network behavior and user satisfaction.

The system may include an analytical AI engine designed to process and analyze data inputs from various sources. The analytical AI engine may handle both structured system data and unstructured user feedback data.

The analytical AI engine may incorporate predictive models to analyze historical trends and generate forecasts. These predictive models may be trained on past network performance data and user experience metrics. By analyzing patterns in historical data, the predictive models may identify potential network issues or user experience degradations before they occur.

The analytical AI engine may utilize classification algorithms to categorize events based on severity or impact. These algorithms may be designed to sort network events or user feedback into predefined categories, allowing for more targeted analysis and response strategies.

The analytical AI engine may process structured data, which may include quantitative network performance metrics such as bandwidth usage, error rates, and latency. Simultaneously, the engine may analyze unstructured data, which may comprise qualitative information from user feedback, support cases, or surveys.

By combining the analysis of both structured and unstructured data, the analytical AI engine may provide a more comprehensive understanding of network performance and its impact on user satisfaction. This integrated approach may allow for the identification of subtle relationships between technical metrics and user-reported experiences.

The analytical AI engine may identify patterns in network performance and correlate these patterns with user experience metrics. For example, the engine may detect recurring patterns of network congestion and associate them with spikes in user complaints or decreased satisfaction scores.

The analytical AI engine may also be capable of detecting anomalies in both the structured system data and the unstructured user feedback data. These anomalies may represent unusual network behavior or unexpected patterns in user responses that warrant further investigation.

By processing data through predictive models and classification algorithms, the analytical AI engine may generate insights that can be used to inform decision-making and guide system optimizations. The engine's outputs may serve as inputs for other components of the system, such as correlation engines or recommendation modules.

The system may include a correlation AI engine designed to identify relationships between network performance and user experience. The correlation AI engine may employ time-series analysis techniques to map specific network events to corresponding user feedback.

The correlation AI engine may be responsible for identifying connections between network performance data and user experience information. The engine may generate time-aligned embeddings of structured system data and sentiment-weighted experiential data. This alignment process may enable more accurate comparisons between network performance metrics and user satisfaction indicators over time.

The correlation AI engine may utilize time-series analysis to map network events to corresponding user feedback. For example, the engine may correlate a spike in network latency with a subsequent increase in negative user sentiment or support tickets. By analyzing these temporal relationships, the engine may identify patterns or recurring issues that impact user experience.

The correlation AI engine may be configured to handle multi-dimensional correlations. These correlations may factor in various variables, including geographical location, time of day, and device type. By considering multiple dimensions, the engine may provide a more nuanced understanding of the relationships between network events and user experiences.

The correlation AI engine may compute relationships between network events and user dissatisfaction using time-series correlation methods. Additionally, the engine may employ multi-dimensional vector analysis techniques to further refine these computations. This approach may allow for a more comprehensive analysis of how different network performance factors interact to influence user satisfaction.

The multi-dimensional correlation capabilities of the engine may enable a more detailed analysis of network performance impacts. By considering factors such as geography, time of day, and device type, the engine may identify patterns or issues that might not be apparent through simpler analysis methods. For example, the engine may detect that certain network performance issues have a more significant impact on user experience during peak usage hours or in specific geographical regions.

The correlation AI engine may produce output signals based on its analysis. These output signals may represent identified relationships or patterns between network performance and user experience. The signals may serve as inputs for other components of the system, such as recommendation engines or action operators, to inform decision-making and guide system optimizations.

The correlation AI engine may continuously process new data and refine its models over time. This ongoing analysis may allow the engine to adapt to changing network conditions and evolving user expectations, potentially improving the accuracy and relevance of its identified relationships between network performance and user experience.

The system may include a recommendation AI engine designed to provide actionable insights based on the analysis of network performance and user experience data. The recommendation AI engine may utilize the outputs from other system components, such as the correlation AI engine, to generate its recommendations.

The recommendation AI engine may be configured to provide recommendations across multiple domains related to network performance and user experience. The engine may generate suggestions for network configuration changes. These recommendations may include adjustments to bandwidth allocation, routing protocols, or other network parameters to address identified performance issues.

The recommendation AI engine may produce recommendations for application optimizations. These suggestions may focus on improving the performance or efficiency of specific applications that utilize the network infrastructure. The engine may analyze application usage patterns and performance metrics to identify areas for potential enhancement.

The recommendation AI engine may also generate user-oriented tips or suggestions. These recommendations may be designed to help end-users optimize their network experience or mitigate issues they may be encountering. For example, the engine may suggest optimal times for bandwidth-intensive activities or provide troubleshooting steps for common connectivity problems.

The recommendation AI engine may incorporate predictive capabilities. By analyzing historical trends and patterns in network performance and user experience data, the engine may anticipate potential issues before they occur. This predictive functionality may allow the system to suggest proactive measures to prevent performance degradation or user dissatisfaction.

The recommendation AI engine may prioritize its recommendations based on various factors. The engine may consider the potential impact of each suggestion on overall network performance or user satisfaction. The engine may also assess the risk associated with implementing each recommendation, allowing for a balanced approach to system optimization.

The recommendation AI engine may utilize generative AI techniques to produce its recommendations. The engine may employ natural language generation capabilities to create clear, human-readable explanations of its suggestions. This approach may help ensure that the recommendations are easily understood and actionable by system operators or end-users.

The recommendation AI engine may continuously refine its recommendation strategies based on feedback and observed outcomes. The engine may monitor the effectiveness of implemented recommendations and adjust its future suggestions accordingly. This adaptive approach may allow the engine to improve the relevance and impact of its recommendations over time.

By providing actionable insights and predictive capabilities, the recommendation AI engine may contribute to ongoing improvements in network performance and user satisfaction. The engine's ability to generate targeted, multi-domain recommendations may enable more effective and proactive management of network resources and user experiences.

The system may include an action operator configured to implement changes based on recommendations generated by other components. The action operator may translate recommendations into executable tasks that can be applied to the network infrastructure.

The action operator may be designed to implement changes through automated processes. These automated tasks may be executed based on user consent, allowing for a balance between automation and human oversight. This approach may provide operators with control over significant system modifications while still leveraging the efficiency of automated processes.

The action operator may include monitoring capabilities to track the outcomes of implemented changes. These monitoring features may allow the system to assess the effectiveness of modifications and detect any unintended consequences or performance issues resulting from the changes.

The action operator may incorporate rollback features as part of its functionality. These features may enable the system to revert changes in response to detected performance regressions or other issues. The ability to roll back modifications may help maintain system stability and prevent prolonged negative impacts from unsuccessful changes.

The action operator may be capable of triggering rollback operations without human intervention. This automated rollback capability may allow for rapid response to performance issues, potentially minimizing downtime or service degradation.

The action operator may provide clear transparency on the actions being taken. The operator may generate reports or logs detailing the changes implemented, the reasons for those changes, and the observed outcomes. This transparency may facilitate better understanding and oversight of the system's operations.

By combining automated implementation, monitoring, and rollback capabilities, the action operator may enable more efficient management of network changes. This approach may allow for rapid response to identified issues while maintaining safeguards against potential negative impacts.

The system may incorporate a continuous feedback loop to refine its analysis and recommendations over time. The feedback loop may enable the system to learn from actions taken and results observed, potentially improving the accuracy and effectiveness of future predictions and correlations.

The feedback mechanism may collect information on the outcomes of implemented recommendations. The system may monitor network performance metrics and user experience indicators following the application of suggested changes. This monitoring process may allow the system to assess the effectiveness of its recommendations and identify any unintended consequences.

The feedback loop may incorporate user engagement data into its learning process. The system may track changes in user behavior or responses to implemented recommendations. For example, the system may analyze whether users report fewer issues or demonstrate increased satisfaction following specific network optimizations.

The continuous feedback loop may also utilize survey data as part of its learning process. The system may collect and analyze user feedback through targeted surveys or questionnaires. This survey data may provide additional context for understanding the impact of system actions on user experience.

The system may use the collected feedback data to refine its predictive models and correlation algorithms. The system may adjust the weights or parameters of its analytical models based on observed outcomes. This adaptive approach may allow the system to improve its ability to anticipate network issues and generate more effective recommendations over time.

The feedback loop may enable the system to identify patterns or trends in the effectiveness of different types of recommendations. The system may analyze which categories of suggestions tend to yield the most positive outcomes across various network scenarios. This analysis may inform future recommendation strategies, potentially prioritizing approaches that have demonstrated consistent success.

The continuous feedback mechanism may also contribute to the system's ability to adapt to changing network conditions and evolving user expectations. The system may use feedback data to detect shifts in usage patterns or performance requirements over time. This adaptability may allow the system to maintain relevance and effectiveness in dynamic network environments.

The feedback loop may incorporate error analysis to identify and learn from unsuccessful recommendations or actions. The system may examine cases where implemented changes did not yield the expected improvements or led to negative outcomes. This error analysis process may help refine the system's decision-making algorithms and improve its ability to assess potential risks associated with different recommendations.

The continuous feedback loop may operate across multiple timescales. The system may incorporate short-term feedback to make rapid adjustments to ongoing optimizations. Additionally, the system may analyze long-term trends and outcomes to inform broader strategic improvements to its analytical and recommendation capabilities.

By integrating this continuous feedback mechanism, the system may achieve ongoing refinement of its predictive and analytical capabilities. This iterative learning process may contribute to the system's ability to provide increasingly accurate and effective recommendations for enhancing network performance and user experience over time.

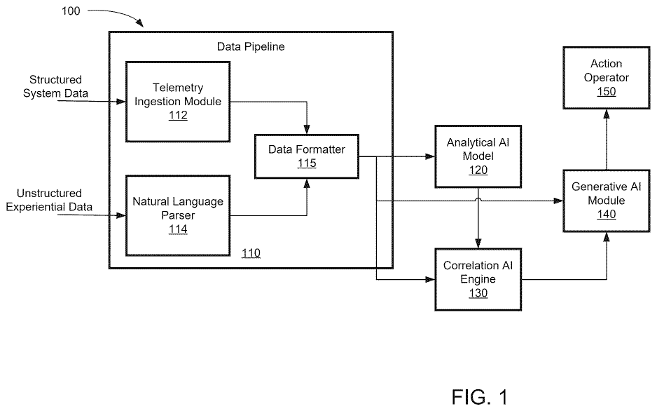

FIG. 1 illustrates a block diagram of a system 100 for processing and analyzing data using artificial intelligence. The system 100 may include multiple components designed to collect, process, and analyze network performance data and user experience information.

The system 100 may comprise a data pipeline 110. The data pipeline 110 may be configured to receive and process both structured system data and unstructured experiential data. The data pipeline 110 may prepare the incoming data for further analysis by other components of the system 100.

The system 100 may include an analytical AI model 120. The analytical AI model 120 may be designed to analyze the processed data from the data pipeline 110. The analytical AI model 120 may employ various machine learning techniques to identify patterns and anomalies in the network performance and user experience data.

A correlation AI engine 130 may be part of the system 100. The correlation AI engine 130 may be configured to establish relationships between network performance metrics and user experience indicators. The correlation AI engine 130 may utilize time-series analysis and multi-dimensional correlation techniques to map network events to user feedback.

The system 100 may incorporate a generative AI module 140. The generative AI module 140 may be designed to produce recommendations based on the outputs from the analytical AI model 120 and the correlation AI engine 130. The generative AI module 140 may utilize natural language generation capabilities to create human-readable suggestions for system improvements.

An action operator 150 may be included in the system 100. The action operator 150 may be responsible for implementing changes based on the recommendations generated by the generative AI module 140. The action operator 150 may include automated deployment capabilities and monitoring features to track the outcomes of implemented changes.

The components of the system 100 may be interconnected, allowing for the flow of data and information between different modules. This interconnected structure may enable the system 100 to perform comprehensive analysis of network performance and user experience, generate targeted recommendations, and implement improvements to enhance overall network functionality.

The data pipeline 110 of the system 100 may include multiple components designed to process both structured and unstructured data inputs. The data pipeline 110 may comprise a telemetry ingestion module 112, a natural language parser 114, and a data formatter 115.

A telemetry ingestion module 112 may be configured to receive and process structured system data. The telemetry ingestion module 112 may collect network performance metrics from various network devices and infrastructure components. The telemetry ingestion module 112 may handle data such as bandwidth usage statistics, error rates, and latency measurements.

The data pipeline 110 may include a natural language parser 114 designed to process unstructured experiential data. The natural language parser 114 may extract relevant information from user feedback, support tickets, or survey responses. The natural language parser 114 may employ various techniques to analyze text and identify key sentiments or issues reported by users.

A data formatter 115 may be incorporated into the data pipeline 110 to standardize and prepare the collected data for further analysis. The data formatter 115 may receive inputs from both the telemetry ingestion module 112 and the natural language parser 114. The data formatter 115 may transform the diverse data inputs into a consistent format suitable for processing by other components of the system 100, such as the analytical AI model 120 or the correlation AI engine 130.

The data formatter 115 may perform data cleaning operations to remove inconsistencies or errors in the collected information. The data formatter 115 may also apply normalization techniques to ensure that data from different sources can be effectively compared and analyzed together.

The components of the data pipeline 110 may work in concert to process and prepare diverse data inputs for analysis. By handling both structured telemetry data and unstructured user feedback, the data pipeline 110 may enable the system 100 to develop a comprehensive understanding of network performance and user experience.

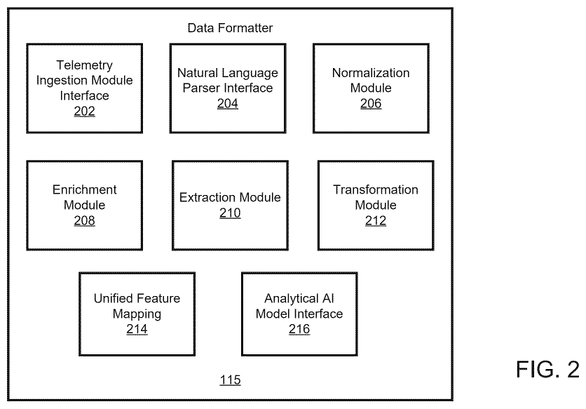

FIG. 2 illustrates a block diagram of the data formatter 115. The data formatter 115 may include multiple components designed to process and standardize data inputs from various sources within the system 100.

The data formatter 115 may comprise a telemetry ingestion module interface 202. The telemetry ingestion module interface 202 may be configured to receive structured data inputs from the telemetry ingestion module 112. The telemetry ingestion module interface 202 may handle network performance metrics and other quantitative data collected from network devices and infrastructure components.

The data formatter 115 may include a natural language parser interface 204. The natural language parser interface 204 may be designed to accept unstructured data inputs from the natural language parser 114. The natural language parser interface 204 may receive processed user feedback, sentiment analysis results, or other qualitative data extracted from textual sources.

The data formatter 115 may incorporate a normalization module 206. The normalization module 206 may be responsible for standardizing data from different sources to ensure consistency in format and scale. This normalization process may enable more effective comparison and analysis of diverse data types within the system 100.

The data formatter 115 may include an enrichment module 208. The enrichment module 208 may be configured to augment the incoming data with additional context or metadata. The enrichment module 208 may add timestamps, source identifiers, or other relevant information to enhance the utility of the data for subsequent analysis.

An extraction module 210 may be part of the data formatter 115. The extraction module 210 may be designed to identify and isolate specific data points or features of interest from the incoming data streams. The extraction module 210 may apply filtering techniques or pattern recognition algorithms to select relevant information for further processing.

The data formatter 115 may incorporate a transformation module 212. The transformation module 212 may be responsible for converting data between different formats or representations as needed. The transformation module 212 may perform operations such as data type conversion, unit conversion, or structural reorganization of data elements.

A unified feature mapping 214 may be included in the data formatter 115. The unified feature mapping 214 may be designed to create a consistent representation of features across different data sources. The unified feature mapping 214 may align and correlate data points from structured telemetry inputs and unstructured user feedback to enable integrated analysis.

The data formatter 115 may comprise an analytical AI model interface 216. The analytical AI model interface 216 may be configured to prepare and format the processed data for input into the analytical AI model 120. The analytical AI model interface 216 may ensure that the data meets the required structure and format specifications for effective analysis by the AI components of the system 100.

By incorporating these various components, the data formatter 115 may enable the system 100 to process and integrate diverse data inputs effectively. The standardized and enriched data outputs from the data formatter 115 may facilitate more comprehensive and accurate analysis of network performance and user experience by subsequent components of the system 100.

The data formatter 115 may include several processing modules designed to standardize and prepare data for analysis within the system 100. These processing modules may work together to transform diverse data inputs into a consistent and usable format.

The normalization module 206 may be responsible for standardizing data from various sources. The normalization module 206 may adjust the scale or units of measurement for different data types to ensure consistency. For example, the normalization module 206 may convert all time-based metrics to a standard unit, such as milliseconds, regardless of the original format in which the data was received.

The enrichment module 208 may augment the incoming data with additional context or metadata. The enrichment module 208 may add timestamps to data points that lack temporal information. The enrichment module 208 may also append source identifiers or categorization tags to help track the origin and type of each data element.

The extraction module 210 may be designed to identify and isolate specific data points or features of interest from the incoming data streams. The extraction module 210 may apply filtering techniques to select relevant information based on predefined criteria. The extraction module 210 may also employ pattern recognition algorithms to detect and extract recurring data structures or significant events within the telemetry or user feedback data.

The transformation module 212 may be responsible for converting data between different formats or representations as needed. The transformation module 212 may perform data type conversions, such as changing string representations of numbers into numerical formats for computational analysis. The transformation module 212 may also restructure data, for example, by pivoting tabular data or flattening hierarchical structures to facilitate analysis by the analytical AI model 120.

These processing modules within the data formatter 115 may operate in a coordinated manner to prepare data for subsequent analysis. The outputs from these modules may feed into the unified feature mapping 214, which may create a consistent representation of features across different data sources. This processed and standardized data may then be made available through the analytical AI model interface 216 for further analysis within the system 100.

The data formatter 115 may include output components designed to prepare processed data for analysis within the system 100. These output components may comprise the unified feature mapping 214 and the analytical AI model interface 216, as illustrated in FIG. 2.

The unified feature mapping 214 may be configured to create a consistent representation of features across different data sources. The unified feature mapping 214 may align and correlate data points from structured telemetry inputs and unstructured user feedback. This alignment process may enable integrated analysis of diverse data types within the system 100.

The unified feature mapping 214 may apply standardized labels or identifiers to features extracted from different data streams. This standardization may facilitate easier comparison and analysis of related information across multiple data sources. For example, the unified feature mapping 214 may associate network performance metrics from the telemetry ingestion module interface 202 with corresponding user experience indicators from the natural language parser interface 204.

The unified feature mapping 214 may also be responsible for resolving inconsistencies or conflicts in feature representations from different sources. The unified feature mapping 214 may apply predefined rules or heuristics to determine the most appropriate representation when discrepancies arise.

The analytical AI model interface 216 may be designed to prepare and format the processed data for input into the analytical AI model 120. The analytical AI model interface 216 may ensure that the data meets the required structure and format specifications for effective analysis by the AI components of the system 100.

The analytical AI model interface 216 may perform final data transformations or encodings necessary for compatibility with the analytical AI model 120. This may involve converting categorical data into numerical representations, normalizing numerical features to a common scale, or applying dimensionality reduction techniques to optimize the data for analysis.

The analytical AI model interface 216 may also handle data partitioning or sampling. This functionality may be useful for preparing training, validation, and test datasets for machine learning models within the analytical AI model 120. The analytical AI model interface 216 may apply various sampling strategies to ensure representative subsets of data are used in model development and evaluation.

The analytical AI model interface 216 may include mechanisms for data versioning and tracking. These mechanisms may help maintain consistency between the data used for model training and the data used for ongoing analysis. This versioning capability may also facilitate reproducibility of analytical results and support iterative refinement of the analytical AI model 120.

By incorporating the unified feature mapping 214 and the analytical AI model interface 216, the data formatter 115 may provide a bridge between the raw data inputs and the advanced analytical capabilities of the system 100. These components may work together to ensure that the diverse data collected by the system 100 is transformed into a consistent, well-structured format suitable for sophisticated AI-driven analysis of network performance and user experience.

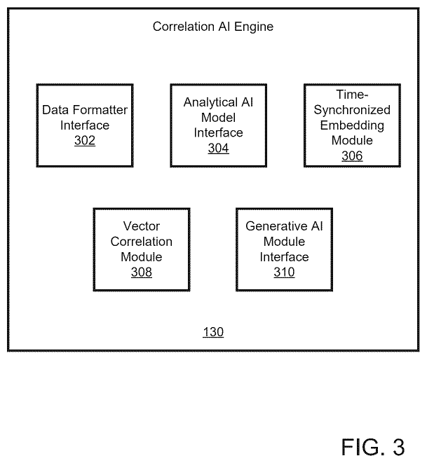

FIG. 3 illustrates a block diagram of the correlation AI engine 130. The correlation AI engine 130 may include multiple components designed to process and analyze data from various sources within the system 100.

The correlation AI engine 130 may comprise a data formatter interface 302. The data formatter interface 302 may be configured to receive processed data from the data formatter 115. The data formatter interface 302 may handle both structured telemetry data and unstructured user feedback that has been standardized and prepared for analysis.

The correlation AI engine 130 may include an analytical model interface 304. The analytical model interface 304 may be designed to interact with the analytical AI model 120. The analytical model interface 304 may receive outputs from the analytical AI model 120, such as identified patterns or anomalies in network performance and user experience data.

The correlation AI engine 130 may incorporate a time synchronization module 306. The time synchronization module 306 may be responsible for aligning data points from different sources based on their temporal attributes. This synchronization process may enable more accurate correlation of network events with user feedback over time.

The correlation AI engine 130 may include a vector correlation module 308. The vector correlation module 308 may be configured to compute relationships between different data features using multi-dimensional analysis techniques. The vector correlation module 308 may identify complex patterns or dependencies that may not be apparent through simpler correlation methods.

A generative module interface 310 may be part of the correlation AI engine 130. The generative module interface 310 may be designed to communicate with the generative AI module 140. The generative module interface 310 may provide correlation results to the generative AI module 140 for use in generating recommendations or insights.

By incorporating these various components, the correlation AI engine 130 may enable the system 100 to establish relationships between network performance metrics and user experience indicators. The modular structure of the correlation AI engine 130 may allow for flexible and comprehensive analysis of diverse data types within the system 100.

The correlation AI engine 130 may include processing modules designed to analyze relationships between network performance metrics and user experience indicators. These processing modules may comprise the time synchronization module 306 and the vector correlation module 308, as illustrated in FIG. 3.

The time synchronization module 306 may be configured to align data points from different sources based on their temporal attributes. The time synchronization module 306 may process timestamps associated with network telemetry data and user feedback to create a unified timeline. This synchronization process may enable more accurate correlation of network events with user experience indicators over time.

The time synchronization module 306 may apply interpolation techniques to handle data streams with different sampling rates. The time synchronization module 306 may estimate values at specific time points to ensure consistent temporal resolution across all data sources. This approach may facilitate the identification of temporal patterns and cause-effect relationships between network performance and user satisfaction.

The vector correlation module 308 may be designed to compute relationships between different data features using multi-dimensional analysis techniques. The vector correlation module 308 may represent network performance metrics and user experience indicators as multi-dimensional vectors. The vector correlation module 308 may then apply mathematical operations to quantify the similarities or differences between these vectors.

The vector correlation module 308 may utilize cosine similarity measures to assess the alignment between network performance vectors and user experience vectors. The vector correlation module 308 may also employ dimensionality reduction techniques, such as principal component analysis, to identify the most significant factors contributing to observed correlations.

The vector correlation module 308 may be capable of detecting non-linear relationships between data features. The vector correlation module 308 may apply kernel methods or neural network-based approaches to capture complex interactions that may not be apparent through linear correlation analysis.

By incorporating the time synchronization module 306 and the vector correlation module 308, the correlation AI engine 130 may enable sophisticated analysis of temporal and multi-dimensional relationships within the system 100. These processing modules may work together to provide insights into how network performance metrics correlate with user experience indicators across various timescales and feature spaces.

The correlation AI engine 130 may include an output interface designed to communicate the results of its analysis to other components within the system 100. This output interface may be implemented as the generative module interface 310, as illustrated in FIG. 3.

The generative module interface 310 may be configured to format and transmit the correlation results produced by the correlation AI engine 130. The generative module interface 310 may prepare the correlation data in a structure suitable for consumption by the generative AI module 140.

The generative module interface 310 may apply data serialization techniques to package the correlation results. The generative module interface 310 may convert complex data structures into a format that can be efficiently transmitted and reconstructed by the receiving components. This serialization process may ensure that the full context and relationships identified by the correlation AI engine 130 are preserved when passed to the generative AI module 140.

The generative module interface 310 may include mechanisms for data compression. These compression techniques may reduce the volume of data transferred between the correlation AI engine 130 and the generative AI module 140, potentially improving system performance and reducing bandwidth requirements.

The generative module interface 310 may incorporate error handling and validation features. These features may ensure the integrity of the data being transmitted and provide mechanisms for detecting and addressing any issues that may arise during the data transfer process.

The generative module interface 310 may be designed with flexibility to accommodate various types of correlation outputs. The generative module interface 310 may handle both structured correlation metrics and unstructured relationship descriptions. This flexibility may allow the correlation AI engine 130 to communicate a wide range of insights to the generative AI module 140.

The generative module interface 310 may include metadata alongside the correlation results. This metadata may provide additional context about the analysis performed, such as the time range considered, the specific data sources used, or the confidence levels associated with the identified correlations.

The generative module interface 310 may support bidirectional communication with the generative AI module 140. This bidirectional capability may allow the generative AI module 140 to request specific types of correlation analysis or additional details about particular relationships identified by the correlation AI engine 130.

By incorporating the generative module interface 310, the correlation AI engine 130 may establish a robust connection with the generative AI capabilities of the system 100. This interface may enable the seamless flow of correlation insights, supporting the generation of data-driven recommendations and actions to enhance network performance and user experience.

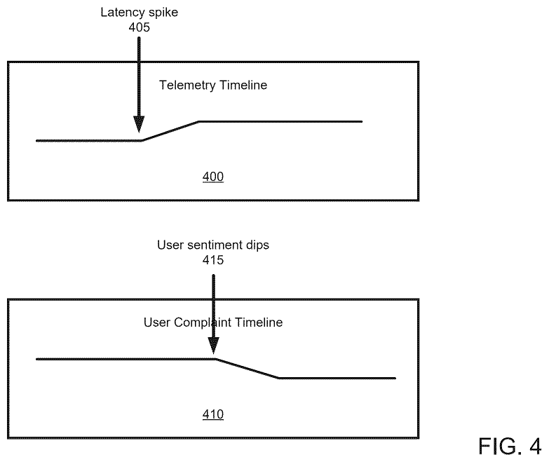

FIG. 4 illustrates a relationship between network telemetry and user complaints within the system 100. The figure depicts two parallel timelines that may be used by the correlation AI engine 130 to analyze the connection between network performance and user experience.

The system 100 may include a telemetry timeline 400. The telemetry timeline 400 may represent a chronological sequence of network performance data collected by the telemetry ingestion module 112. The telemetry timeline 400 may display various network metrics over time, providing a visual representation of the network's operational status.

The telemetry timeline 400 may include a latency spike 405. The latency spike 405 may represent a sudden increase in network latency at a specific point in time. The latency spike 405 may be detected and processed by the analytical AI model 120 as part of its analysis of network performance patterns.

The system 100 may also incorporate a user complaint timeline 410. The user complaint timeline 410 may represent a chronological sequence of user feedback data processed by the natural language parser 114. This timeline may provide insights into user sentiment and reported issues over time.

Within the user complaint timeline 410, the system 100 may identify a user sentiment dip 415. The user sentiment dip 415 may indicate a decrease in user satisfaction or an increase in reported issues. The user sentiment dip 415 may occur shortly after the latency spike 405 on the telemetry timeline 400.

The correlation AI engine 130 may analyze the relationship between the telemetry timeline 400 and the user complaint timeline 410. The time synchronization module 306 may align the two timelines to ensure accurate temporal correlation. The vector correlation module 308 may then compute the relationship between the latency spike 405 and the user sentiment dip 415.

By examining the temporal proximity between the latency spike 405 and the user sentiment dip 415, the correlation AI engine 130 may establish a potential causal relationship between network performance issues and user dissatisfaction. This correlation may be used by the generative AI module 140 to generate recommendations for improving network performance and user experience.

The data formatter 115 may process the information from both timelines, standardizing the data for analysis. The analytical AI model 120 may then use this processed data to identify patterns or recurring issues that may impact user satisfaction.

The action operator 150 may use the insights derived from the correlation between the telemetry timeline 400 and the user complaint timeline 410 to implement targeted improvements to the network infrastructure. These actions may aim to prevent future latency spikes and mitigate their impact on user experience.

The visualization of the telemetry timeline 400 and user complaint timeline 410 in FIG. 4 may provide a clear representation of how network performance metrics correlate with user experience indicators. This visual correlation may support the system 100 in developing more effective strategies for enhancing network performance and user satisfaction.

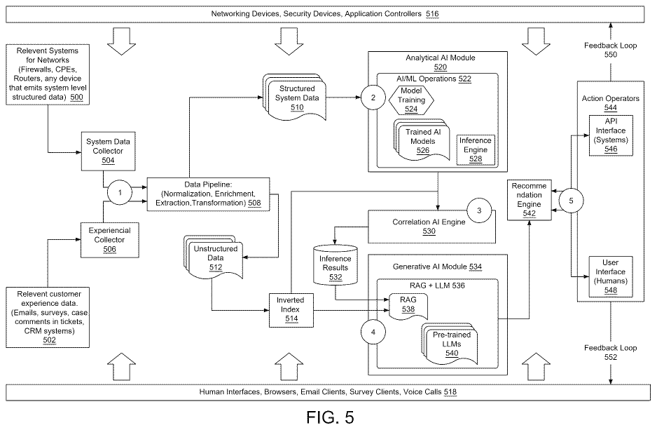

FIG. 5 illustrates a system diagram of the system for enhancing network experience through the processing of data using multiple artificial intelligence components. The system may receive system level structured data 500 through various telemetry channels 516, such as network devices, security devices, application controllers, etc. The system may also receive structured and/or unstructured relevant customer experience data 506 through various human channels 518 such as human interfaces, browsers, email clients, survey clients, voice calls, comments in customer service tickets, data from customer relationship management (CRM) systems, etc. A system data collector 504 may aggregate the system level structured data 500, and an experiencial collector 506 may aggregate relevant customer experience data 506. The system data collector 504 and the experiencial collector 506 may provide aggregated data as input from external sources 1.

The input from external sources 1 may be part of a data pipeline 508, such as the data pipeline 110, and may handle both structured and unstructured data. The structured system data 510 may be collected by the telemetry ingestion module 112, while the unstructured data 512 may be gathered from user feedback and experiences by the natural language parser 114. An inverted index 514 may be used to retrieve relevant information for the unstructured data 512.

The system may incorporate an analytical AI module 520. The analytical AI model 520 may process collected structured system data 510 as input 2 from the input from the data pipeline 508. The analytical AI module 520 may perform operations such as model training 524, one or more trained AI model(s) 526, and an inference engine 528. The analytical AI module 520 may analyze patterns and metrics from the incoming data streams processed by the data formatter 115. A correlation AI engine 530 may be included in the system. The correlation AI engine 530 may connect with the analytical AI module 520 and other system components. The correlation AI engine 530 may take as input, the output from the analytical AI module 520 and/or the unstructured data 512, as well as any relevant information retrieved from the inverted index 514. The correlation AI engine 530 may process the relationships between different data points and metrics using the time synchronization module 306 and the vector correlation module 308. The correlation AI engine 530 may help establish connections between network performance data from the telemetry timeline 400 and user experience data from the user complaint timeline 410. The correlation AI engine 530 may output inference results 532.

The system may include a generative AI module 534. The generative AI module 534 may incorporate a RAG and LLM platform 536. The RAG and LLM platform 536 may comprise a RAG 538 and one or more pre-trained LLMs 540. The generative AI module 534 may take as input the inference results 532 and/or the unstructured data 512, as well as any relevant information retrieved from the inverted index 514. The generative AI module 534 may produce recommendations based on the processed data. The generative AI module 534 may work in conjunction with the correlation AI engine 530 to generate actionable insights through the generative module interface 310.

The system may include a recommendation engine 542, action operators 544, and bidirectional communication 5 between the recommendation engine 542 and the action operators 544. The recommendation engine 542 may receive as input the output of the generative AI module 534. The action operators 544 may include an API 546 to facilitate communication with network devices, security devices, application controllers, etc. The action operators may include a user interface 548 to facilitate communication with users.

The system may include feedback loops 550, 552 that connect the various components, allowing for continuous improvement and refinement of the system's outputs. The processed information may flow through to the action operators 544, such as the action operator 150, which may implement recommended changes and present information to users.

The data flow within the system may begin with the input from external sources 1 collecting data from telemetry channels 516, such as networking devices, security devices, application controllers, etc. and data from human interfaces, browsers, email clients, survey clients, voice calls, comments in customer service tickets, data from customer relationship management (CRM) systems, etc. This data may then be processed by the data pipeline 508, which may include the telemetry ingestion module interface 202 and the natural language parser interface 204.

The processed structured system data 510 may then flow as input 2 to the analytical AI module 520, which may analyze the data using various machine learning techniques. The outputs from the analytical AI module 520 may be passed as input 3 to the correlation AI engine 530 through the analytical model interface 304.

The correlation AI engine 530 may also receive the unstructured data 512, as well as relevant information retrieved from the inverted index 514 as input 3. The correlation AI engine 530 may then process the relationships between the analyzed data, potentially identifying connections between network events like the latency spike 405 and user reactions such as the user sentiment dip 415. The results of this correlation analysis may be sent to the generative AI model 4 through the generative module interface 310.

The generative AI module534 may receive the inference results 532 as input 4. The generative AI module 534 may also receive the unstructured data 512, as well as relevant information retrieved from the inverted index 514 as input 4. The generative AI module 534 may use the correlated data to generate recommendations or insights. These recommendations may then be passed to the action operators 544, which may implement changes to the network infrastructure or present information to users through various interfaces such as browsers, email clients, or voice calls.

By processing data through these multiple AI components, the system 100 may provide a comprehensive approach to enhancing network experience. The system 100 may continuously analyze network performance metrics and user feedback, generate insights, and implement improvements to optimize network functionality and user satisfaction.

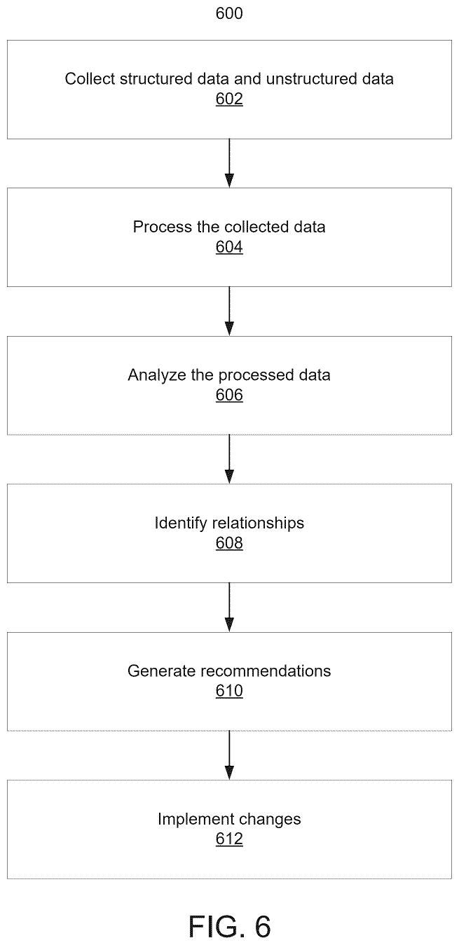

FIG. 6 illustrates a flowchart of methods 600 for collecting and processing data to enhance network experience.

Structured and unstructured data may be collected (block 602). The structured data may comprise system data. The unstructured data may comprise experiential data. The structured and unstructured data may be collected to generate collected data. The structured system data may comprise network performance metrics including bandwidth usage, error rates, and latency. The unstructured experiential data may comprise user feedback from support cases and surveys.

The structured data collected in step 602 may include network performance metrics obtained through the telemetry ingestion module 112. These metrics may comprise bandwidth usage statistics, error rates, and latency measurements from network devices and infrastructure components.

The unstructured data collected in step 602 may include user feedback obtained through the natural language parser 114. This feedback may be derived from support cases, surveys, or other forms of user communication. The unstructured data may provide insights into user experiences and satisfaction levels.

The collected data may be processed (block 604). The collected data may be processed through a data pipeline. The collected data may be processed to generate processed data.

The step 604 may involve transforming and standardizing the diverse data inputs to prepare them for analysis. The step 604 may utilize components of the data pipeline 110 to process the collected data. The telemetry ingestion module interface 202 may handle the structured network performance data, while the natural language parser interface 204 may process the unstructured user feedback.

The data formatter 115 may play a role in step 604 by standardizing and integrating the different data types. The normalization module 206 within the data formatter 115 may adjust the scale or units of measurement for various data points to ensure consistency. The enrichment module 208 and extraction module 210 may further process the data during step 604. These modules may augment the data with additional context or isolate specific features of interest for subsequent analysis.

The transformation module 212 may convert data between different formats or representations as needed during step 604. This transformation process may ensure that all data is in a suitable format for analysis by the analytical AI model 120 and other components of the system 100. The unified feature mapping 214 may create a consistent representation of features across different data sources as part of step 604. This mapping process may enable integrated analysis of diverse data types within the system 100.

By implementing steps 602 and 604, the methods 600 may establish a foundation for comprehensive data analysis. The collection and processing of both structured and unstructured data may enable the system 100 to develop a more complete understanding of network performance and user experience, supporting subsequent steps in the methods 600 for enhancing network functionality.

The processed data may be analyzed (block 606). The processed data may be analyzed using an analytical artificial intelligence (AI) module. The analyzing the processed data using the analytical AI module may comprise utilizing predictive models and classification algorithms to identify patterns in network performance and correlate them with user experience metrics.

The step 606 may involve utilizing the analytical AI model 120 to examine the standardized data produced by the data formatter 115. The analytical AI model 120 may employ various techniques to analyze the processed data during step 606. The analytical AI model 120 may utilize predictive models to identify patterns in network performance. These predictive models may examine historical trends in the telemetry data collected by the telemetry ingestion module 112 to forecast potential future network behavior. The analytical AI model 120 may also apply classification algorithms as part of step 606. These algorithms may categorize different types of network events or user feedback, potentially grouping similar occurrences for more efficient analysis. The classification process may help identify recurring issues or common themes in user experiences.

During step 606, the analytical AI model 120 may correlate patterns in network performance with user experience metrics. For example, the analytical AI model 120 may examine how fluctuations in bandwidth usage or latency measurements from the telemetry timeline 400 correspond to changes in user sentiment or complaint frequency from the user complaint timeline 410.

Relationships may be identified (block 608). The identified relationships may be between network performance and user experience. The relationships may be identified using a correlation AI engine based on outputs of the data pipeline and the analytical AI module. The identifying relationships between the network performance and the user experience may further comprise using time-series analysis to map network events to corresponding user feedback. The identifying relationships between the network performance and the user experience may further comprise handling multi-dimensional correlations factoring in variables including geography, time of day, and device type.

The step 608 may utilize the correlation AI engine 130 to establish connections between the analyzed network metrics and user feedback data. The correlation AI engine 130 may employ time-series analysis techniques during step 608 to map network events to corresponding user feedback. The time synchronization module 306 within the correlation AI engine 130 may align the telemetry timeline 400 with the user complaint timeline 410, enabling precise temporal correlation between network performance indicators and user experience metrics.

As part of step 608, the correlation AI engine 130 may be configured to handle multi-dimensional correlations. The vector correlation module 308 may factor in variables such as geographical location, time of day, and device type when computing relationships between network events and user experiences. This multi-dimensional approach may provide a more nuanced understanding of how different factors interact to influence user satisfaction.

The correlation AI engine 130 may use the aligned and multi-dimensional data to identify specific relationships between network performance issues and user complaints. For example, the correlation AI engine 130 may determine how often a latency spike 405 in the telemetry timeline 400 precedes a user sentiment dip 415 in the user complaint timeline 410, and under what conditions this correlation is strongest.

By implementing steps 606 and 608, the methods 600 may enable the system 100 to develop a comprehensive understanding of the relationships between network performance and user experience. The insights generated through this analysis and correlation process may inform subsequent steps in enhancing network functionality and improving user satisfaction.

Recommendations may be generated (block 610). The recommendations may be generated using a generative AI model. The recommendations may be generated based on inputs from the correlation AI engine.

The step 610 may utilize the generative AI module 140 to produce actionable suggestions for improving network functionality and user satisfaction. The generative AI module 140 may receive inputs from the correlation AI engine 130 through the generative module interface 310. These inputs may include the identified relationships between network events and user experiences, such as correlations between the latency spike 405 and the user sentiment dip 415.

During step 610, the generative AI module 140 may analyze the correlated data to develop specific recommendations. These recommendations may address network configuration changes, application adjustments, or user-side tips. For example, if the correlation AI engine 130 identifies a recurring pattern of latency spikes leading to user complaints, the generative AI module 140 may suggest adjustments to bandwidth allocation or routing protocols to mitigate the issue.

The generative AI module 140 may employ natural language generation techniques to formulate its recommendations in a clear, human-readable format. This may involve creating detailed explanations of proposed changes, including the rationale behind each suggestion based on the analyzed data.

Changes may be implemented (block 612). The changes may be implemented based on the generated recommendations. The changes may be implemented using an action operator. The implementing changes may comprise executing automated tasks based on user consent and may include monitoring the implemented changes and providing rollback features. The changes may be implemented via an API call to at least one of a network device, a security device, or an application controller.

The step 612 may involve utilizing the action operator 150 to execute the suggested modifications to the network infrastructure or user-facing systems. The action operator 150 may be configured to implement changes through automated tasks. The action operator 150 may be configured to implement automatic changes based on user consent. The action operator 150 may present the recommendations generated by the generative AI module 140 to system administrators or other authorized personnel for approval before execution.

During step 612, the action operator 150 may include monitoring capabilities to track the outcomes of implemented changes. This monitoring may involve collecting new telemetry data through the telemetry ingestion module 112 and user feedback through the natural language parser 114 to assess the impact of the modifications on network performance and user satisfaction.

The action operator 150 may also incorporate rollback features as part of step 612. These features may allow the system 100 to revert changes if the monitoring process detects unexpected negative impacts on network performance or user experience. This rollback capability may help maintain system stability and prevent prolonged disruptions.

By implementing steps 610 and 612, the methods 600 may enable the system 100 to translate analytical insights into concrete actions for improving network functionality. The combination of data-driven recommendation generation and controlled implementation may support ongoing optimization of network performance and enhancement of user experience.

Although example blocks are shown, some implementations may include additional blocks, fewer blocks, different blocks, or differently arranged blocks than those depicted. Additionally, or alternatively, two or more of the blocks may be performed in parallel.

### EXAMPLES

Example Clause 1: A system for optimizing network performance based on correlated multi-source experiential feedback, comprising: a data pipeline comprising: a telemetry ingestion module configured to collect structured system data including timestamped network performance metrics from network devices; and a natural language parser configured to extract sentiment-weighted indicators from unstructured user feedback data obtained from support cases or surveys; an analytical artificial intelligence (AI) module comprising at least one predictive model or classification algorithm configured to identify patterns and anomalies in the structured system data and the unstructured user feedback data; a correlation AI engine configured to generate time-aligned embeddings of the structured system data and sentiment-weighted experiential data and to compute relationships between network events and user dissatisfaction using time-series correlation and multi-dimensional vector analysis; a generative AI module configured to produce system modification recommendations in response to output signals from the correlation AI engine; and an action operator comprising a network orchestration interface configured to automatically deploy configuration changes to infrastructure nodes, monitor outcomes of the changes, and trigger rollback operations in response to performance regressions, all without human intervention.

Example Clause 2: The system of Example Clause 1, wherein the network performance metrics includes at least one of bandwidth usage, error rates, or latency.

Example Clause 3: The system of Example Clause 1 or Example Clause 2, wherein the unstructured user feedback data comprises audio data.

Example Clause 4: The system of any one of Example Clauses 1-3, wherein the at least one predictive model or classification algorithm identifies patterns in network performance and correlates the patterns with user experience metrics.

Example Clause 5: The system of any one of Example Clauses 1-4, wherein the correlation AI engine uses time-series analysis to map network events to corresponding user feedback.

Example Clause 6: The system of any one of Example Clauses 1-5, wherein the correlation AI engine is configured to handle multi-dimensional correlations factoring in variables including geography, time of day, and device type.

Example Clause 7: The system of any one of Example Clauses 1-6, wherein the action operator is configured to implement changes through automated tasks based on user consent and includes monitoring capabilities and rollback features.

Example Clause 8: A method for enhancing network experience, comprising: collecting structured system data and unstructured experiential data to generate collected data; processing the collected data through a data pipeline to generate processed data; analyzing the processed data using an analytical artificial intelligence (AI) module; identifying relationships between network performance and user experience using a correlation AI engine based on outputs from the data pipeline and the analytical AI module; generating recommendations using a generative AI module based on inputs from the correlation AI engine; and implementing changes based on the generated recommendations using an action operator.

Example Clause 9: The method of Example Clause 8, wherein the structured system data comprises network performance metrics including bandwidth usage, error rates, and latency.

Example Clause 10: The method of Example Clause 8 or Example Clause 9, wherein the unstructured experiential data comprises user feedback from support cases and surveys.

Example Clause 11: The method of any one of Example Clauses 8-10, wherein the analyzing the processed data using the analytical AI module comprises utilizing predictive models and classification algorithms to identify patterns in network performance and correlate them with user experience metrics.

Example Clause 12: The method of any one of Example Clauses 8-11, wherein the identifying relationships between the network performance and the user experience further comprises using time-series analysis to map network events to corresponding user feedback.

Example Clause 13: The method of any one of Example Clauses 8-12, wherein the identifying relationships between the network performance and the user experience further comprises handling multi-dimensional correlations factoring in variables including geography, time of day, and device type.

Example Clause 14: The method of any one of Example Clauses 8-13, wherein the implementing changes comprises executing automated tasks based on user consent and includes monitoring the implemented changes and providing rollback features.

Example Clause 15: A non-transitory computer-readable medium storing instructions that, when executed by a processor, cause the processor to perform operations for enhancing network experience, the operations comprising: collecting structured system data and unstructured experiential data to generate collected data; processing the collected data to generated processed data; analyzing the processed data to generate analyzed data; identifying relationships between network performance and user experience based on the analyzed data; generating recommendations based on the identified relationships; and implementing changes based on the generated recommendations.

Example Clause 16: The non-transitory computer-readable medium of Example Clause 15, wherein the structured system data comprises network performance metrics including bandwidth usage, error rates, and latency.

Example Clause 17: The non-transitory computer-readable medium of Example Clause 15 or Example Clause 16, wherein the unstructured experiential data comprises user feedback from support cases and surveys.

Example Clause 18: The non-transitory computer-readable medium of any one of Example Clauses 15-17, wherein the analyzing the processed data comprises utilizing predictive models and classification algorithms to identify patterns in network performance and correlate them with user experience metrics.

Example Clause 19: The non-transitory computer-readable medium of any one of Example Clauses 15-18, wherein the identifying relationships between the network performance and the user experience further comprises using time-series analysis to map network events to corresponding user feedback.

Example Clause 20: The non-transitory computer-readable medium of any one of Example Clauses 15-19, wherein the identifying relationships between the network performance and the user experience further comprises handling multi-dimensional correlations factoring in variables including geography, time of day, and device type.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context.

Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1.-20. (canceled)

21. A method comprising:
receiving, from a network device, structured system data;
receiving unstructured data comprising user feedback;
determining, based on the structured system data, a plurality of network performance metrics;
determining, based on the unstructured data, a plurality of sentiment-weighted indicators;
determining, based on the plurality of network performance metrics, the plurality of sentiment-weighted indicators, and a correlation artificial intelligence (AI) engine, correlation between network performance and user experience;
automatically generating, based on the correlation between network performance and user experience and using a generative AI module, network recommendations configured to improve network performance or user experience; and
outputting, to a user interface, the network recommendations.

22. The method of claim 21, wherein the structured system data comprises network performance metrics including bandwidth usage, error rates, and latency.

23. The method of claim 21, wherein the unstructured data comprises audio recordings of the user feedback, and further comprising converting the audio recordings to text prior to determining the plurality of sentiment-weighted indicators.

24. The method of claim 21, wherein the determining the correlation between network performance and user experience further comprises utilizing predictive models and classification algorithms trained on historical network data to identify patterns and anomalies.

25. The method of claim 21, wherein the determining the correlation between network performance and user experience comprises handling multi-dimensional correlations factoring in geographical location, time of day, and device type.

26. The method of claim 21, further comprising monitoring network performance after implementing a recommended configuration change and automatically initiating a rollback operation in response to detecting a performance regression.

27. The method of claim 21, wherein the generative AI module employs retrieval-augmented generation utilizing an inverted index of processed experiential data to refine the network recommendations.

28. A method comprising:
receiving, from a network device, structured system data;
receiving unstructured data comprising user feedback;
determining, based on the structured system data, a plurality of network performance metrics;
determining, based on the unstructured data, a plurality of sentiment-weighted indicators;
determining, based on the plurality of network performance metrics, the plurality of sentiment-weighted indicators, and a correlation artificial intelligence (AI) engine, correlation between network performance and user experience;
automatically generating, based on the correlation between network performance and user experience and using a generative AI module, network recommendations configured to improve network performance or user experience; and
automatically implementing the network recommendations without human intervention.

29. The method of claim 28, wherein the plurality of network performance metrics comprise bandwidth usage, error rates, and latency.

30. The method of claim 28, wherein the unstructured data comprises audio recordings of the user feedback, and further comprising converting the audio recordings to text prior to determining the plurality of sentiment-weighted indicators.

31. The method of claim 28, wherein the determining the correlation between network performance and user experience further comprises utilizing predictive models and classification algorithms trained on historical network data to identify patterns and anomalies.

32. The method of claim 28, wherein the determining the correlation between network performance and user experience comprises handling multi-dimensional correlations factoring in geographical location, time of day, and device type.

33. The method of claim 28, further comprising monitoring outcomes of the implemented network recommendations and automatically initiating a rollback operation in response to detecting a performance regression.

34. The method of claim 28, further comprising refining the correlation AI engine or the generative AI module based on feedback data collected after implementation of the network recommendations.

35. A method comprising:
receiving, from a network device, structured system data;
receiving unstructured data comprising user feedback;
determining, based on the structured system data, a plurality of network performance metrics;
determining, based on the unstructured data, a plurality of sentiment-weighted indicators;
determining, based on the plurality of network performance metrics, the plurality of sentiment-weighted indicators, and a correlation artificial intelligence (AI) engine, correlation between network performance and user experience;
generating, based on the correlation between network performance and user experience, network recommendations configured to improve network performance or user experience; and
causing, based on at least the network recommendations, remediation action.

36. The method of claim 35, wherein the determining the correlation between the network performance metric and the sentiment-weighted indicator comprises performing time-series analysis to map the network performance metric to the sentiment-weighted indicator across a defined temporal window.

37. The method of claim 35, wherein determining the correlation between network performance and user experience further comprises handling multi-dimensional correlations factoring in geographical location, time of day, and device type.

38. The method of claim 35, further comprising training a predictive model using historical network performance metrics and sentiment-weighted indicators to forecast correlations between network performance and user experience at future times.

39. The method of claim 35, wherein the unstructured data comprises textual comments, survey responses, or audio recordings, and further comprising extracting sentiment-weighted indicators using a natural language parser.

40. The method of claim 35, wherein automatically generating the network recommendations comprises utilizing retrieval-augmented generation to retrieve contextually relevant experiential data and produce human-readable recommendations.
